(19) United States
(12) Patent Application Publication
(10) Pub. No.: US 2014/0366448 A1
(43) Pub. Date: Dec. 18, 2014

(54) DEVICE FOR OPENING A PANEL, IN PARTICULAR A GLASS PANEL, ON A SALES COUNTER

(71) Applicant: Martin Tschap, Iserlohn (DE)

(72) Inventor: Martin Tschap, Iserlohn (DE)

(73) Assignee: Vieler International GmbH + Co. KG, Iserlohn (DE)

(21) Appl. No.: 14/369,959

(22) PCT Filed: Jan. 11, 2012
(86) PCT No.: PCT/EP2012/000093

§ 371 Date: Jun. 30, 2014

(51) Int. Cl. E05D 3/18; E05D 7/06; E06B 3/50; E05D 11/10

(52) U.S. Cl. CPC E05D 3/18; E05D 11/1014; E05D 7/06; E06B 3/5072
USPC 49/252; 16/357; 16/337

(57) ABSTRACT

A device for opening a panel on a sales counter which includes a basic structure. The panel is arranged on the front side of the sales counter. At least a first profile is provided, as is at least one second profile that is secured on the basic structure. The first profile, with the panel, is pivotable away from the basic structure by a control part. In a closed position, the panel closes the basic structure from the front side of the sales counter, and in an open position it is pivoted away from the basic structure. A control part has one end articulated on the first profile and another end articulated on the second profile or on the basic structure. The first profile is displaceably articulated at its one outer end on the second profile. The control part controls the rotary movement and sliding movement of the first profile.

The invention pertains to a device for opening a panel on a sales counter. Panels of this type are almost always mounted on the front side of sales counters to give customers a view of the merchandise on display. Sales counters of this type are frequently used especially in the area of fresh products such as cheese, sausage, meat, fish, bread, and the like. Several sales counters are often set up next to each other to create a so-called “counter landscape”. The individual sales counters can be designed in different ways. An especially pleasing external appearance is offered by counter landscapes in which sales counters forming so-called inside or outside corners of a counter landscape are used in addition to the normal sales counters comprising a counter framework structure with a rectangular outline.

It is necessary to clean the counter fittings or edge sections of sales counters. In addition, it is often necessary to restock sales counters, especially those in which food products are displayed. In the case of products which are especially heat-sensitive such as fish, it is also usually necessary to load the counter framework structure with ice before the products themselves can be put on display. It is therefore important for the counter framework structure to be designed so that the area where the merchandise is displayed is easily accessible.

EP 1 293 153 B1 describes a device for opening a panel on a sales counter. For this purpose, two support arms are provided, which are parallel to each other and of equal length. Each of the support arms is hinged to the counter and to an edge section carrying the panel. As a result, a kinematic system similar to a parallelogram is obtained. The panel, however, cannot be opened very widely with this system. The inside surface of the panel is not made accessible in this way either and cannot be cleaned. Opening the panel is not ergonomic for the worker, because the worker must move backwards while holding the panel to move it into the opened position.

Another opening system for the panel of a sales counter is described in EP 1 843 681 B1. Here, too, two support arms are provided, but they are of different length. Again, the inside surface of the panel is relatively inaccessible for cleaning in the opened state of the panel. And again, the worker must move backwards, which is not ergonomic.

The goal of the invention is therefore to provide a device for opening a panel of a sales counter which makes it possible to open the panels of both inside and outside corners as well as those of standard sales counters as widely as possible and which also makes it possible for the worker to open the panel easily and ergonomically, thus allowing him or her to clean the interior of the counter and the inside surface of the panel easily. This goal is accomplished according to the invention by the characterizing features of claim 1, which have the following special meaning.

A control part is provided, one end of which is hinged to the first edge section, while the other end is hinged to the second edge section or to the framework structure of the counter. In addition, the first edge section is hinged at one of its ends to the second edge section in such a way that it is free to slide and to rotate. The control part now controls the rotational and sliding movement of the first edge section as the panel is being moved into the open or closed position. In the inventive design of the opening device, it is possible to open panels designed in a wide variety of ways and to open many different types of counter framework structures so as to make the counter accessible to the worker. The opening movement is ergonomic and simple. The worker stands more-or-less in the middle, in front of the counter framework structure, and can guide the panel to the side to open the sales counter. He/she thus does not have to move to a different place. The opening process is therefore easy, free of complications, and ergonomic. In addition, counters designed in a wide variety of ways, especially those forming inside and outside corners, can be opened by means of the inventive device, so that nearly any desired counter landscape is possible. Through the use of a single control part, both weight and material are saved, which makes the device especially inexpensive and attractive.

The control part is preferably arranged in the first and/or the second edge section so that it is free to pivot but not to slide. Thus the panel cannot tip when being opened or closed, and the panel can be handled in a simple, ergonomic manner.

It is especially preferable for the two edge sections and the control part to be arranged in such a way that, in the open position of the panel, at least 75% of the sales counter is accessible from the front. This makes it especially simple to stock the sales counter and to clean it.

A catch device is also preferably provided, which keeps the panel in its closed position on the framework structure of the counter and prevents it from being swung out unintentionally. This is advantageous, because as a result the panel cannot be moved or swung out by mistake by customers or passers-by, thus exposing the sales counter. The panel is held in its closed position and can be opened only by intentionally actuating it.

It is also especially advantageous for the catch device to be movable in the direction perpendicular to the framework structure of the counter and/or to the second edge section and to be securable in that position. This makes it possible to align the panel. Especially in the case of counter landscapes, it thus becomes possible for the panels of various parts of the counter to be lined up with each other, so that a uniform overall visual appearance is obtained.

In an especially preferred exemplary embodiment, one end of the first edge section comprises a hinge, which is mounted on the second edge section with freedom to slide back and forth. It is especially advantageous here for the hinge to be movable in one or more grooves in the second edge section. Of course, the reverse kinematic arrangement is also possible, where the hinge moves along a rib, for example, on the second edge section. Thanks to the provision of a slideable hinge, it is ensured that the first edge section is free to slide in the second section, but that the panel can also be swung outward at the same time. If the hinge is designed so that it can slide directly, there is no need for any additional components such those required when, for example, a hinge is provided on one side and a slideable element on the other. The latter option, of course, is also possible but is not so advantageous.

So that the panel can be aligned even more easily, it is possible to design the control part so that it can be adjusted in the height direction relative to the first and/or to the second edge section. Thus, in particular, the height of the panel can be adjusted, which, again, is especially important when several counters are assembled to form a counter landscape. It can also be advantageous for the inclination of the panel to be adjustable, especially in increments of ±0.5°. Overall, the panel can be adjusted by ±3°. Other increments or a larger overall adjustment range are also conceivable. This, too, makes it easier to align several panels so that they are visually in alignment with each other.

It is advantageous for the first edge section to comprise, in its upper area, at least one sealing lip. As result, it is possible to prevent objects or liquids from intruding into the sections and contaminating them. This is especially important in the case of sales counters for food products, for example.

the sales counter is used as a fish counter, ice is often loaded into the counter to cool the fish. If then some of the ice melts, liquid could intrude into the sections. This is prevented by the sealing lip. Crumbs, dust, or the like will not easily intrude into the sections either when a sealing lip is present

It is also advantageous to provide caps on one or both ends of the first and/or second edge section to cover the end of the section toward the outside. This results in a uniform overall visual impression of the sales counter, and dirt and objects cannot easily intrude into the sections.

According to another exemplary embodiment, the first edge section comprises, on its outside surface, a facing, especially in the form of a coating or a shield separately attached to the section. It is also possible for the panel itself to be attached to the outside surface of the first section to produce a facing. Thus various visual impressions can be obtained for sales counters in a simple manner.

Additional advantages and embodiments can be derived from the following description, from the subclaims, and from the drawings. Several exemplary embodiments of the invention are illustrated in the drawings:

FIG. 1 shows a perspective view of a first embodiment of a sales counter equipped with the invention, with the panel in the closed position;

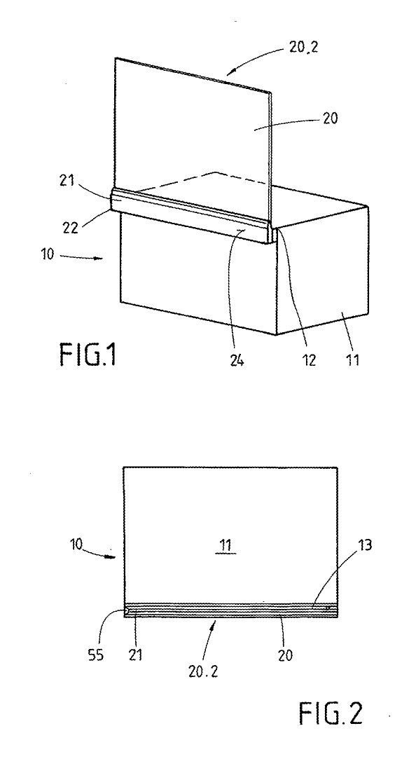

FIG. 2 shows a top view of the sales counter of FIG. 1;

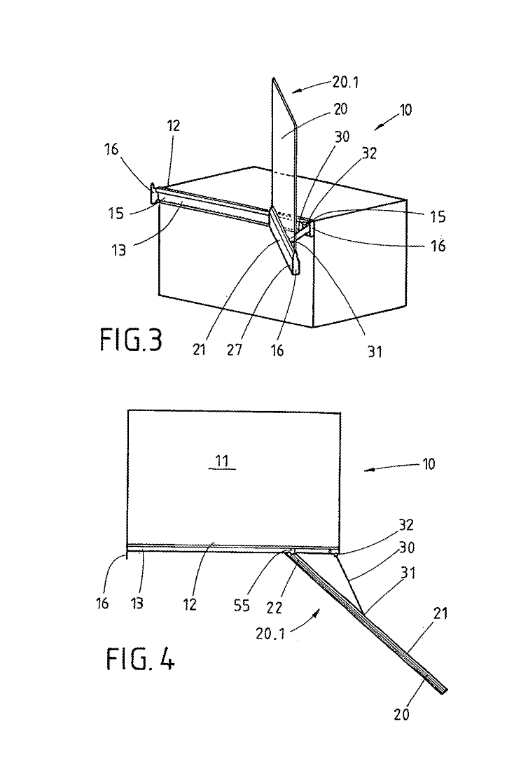

FIG. 3 shows a perspective view of the sales counter of FIG. 1, with the panel in the open position;

FIG. 4 shows a top view of the sales counter of FIG. 3;

FIG. 5 shows another exemplary embodiment of a sales counter, namely, an outside corner, with the panel in the open position;

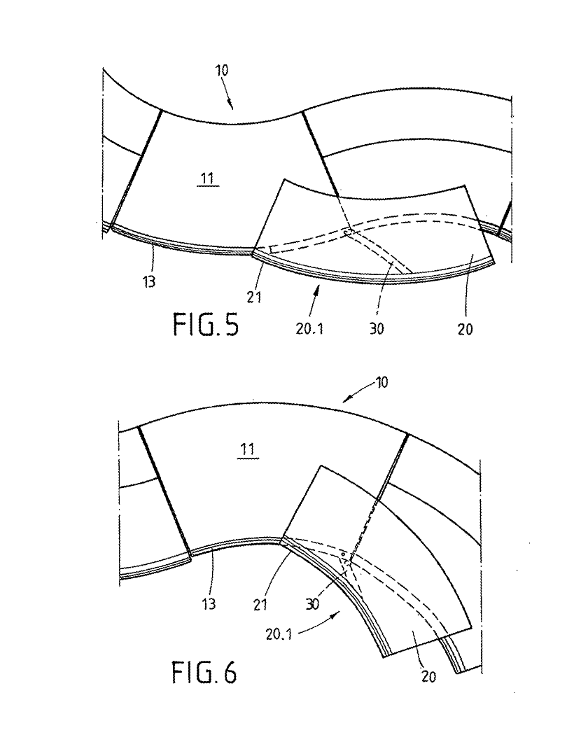

FIG. 6 shows another exemplary embodiment of a sales counter, namely, an inside corner, with the panel in the open position;

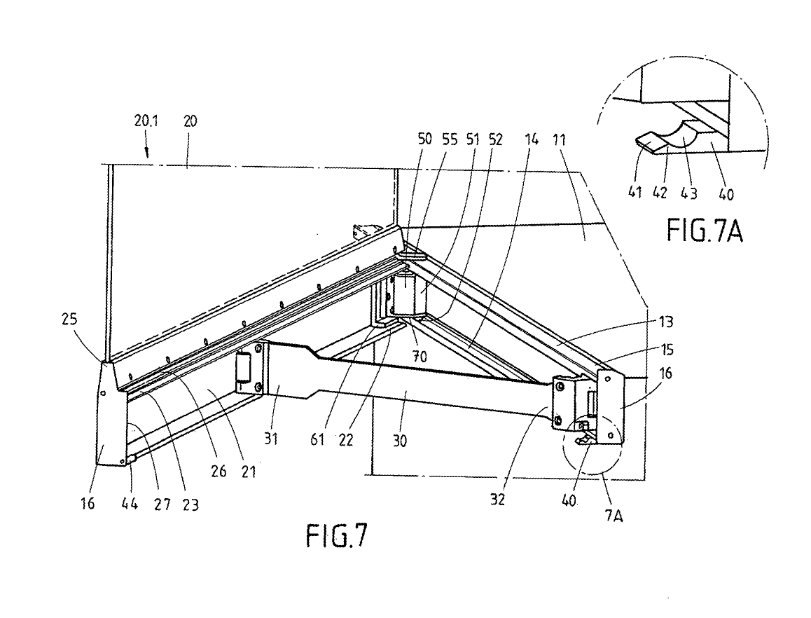

FIG. 7 shows the arrangement of the two edge sections and of the control part, with the panel in the open position;

FIG. 7A shows an enlarged view of the partial area 7A circled in FIG. 7;

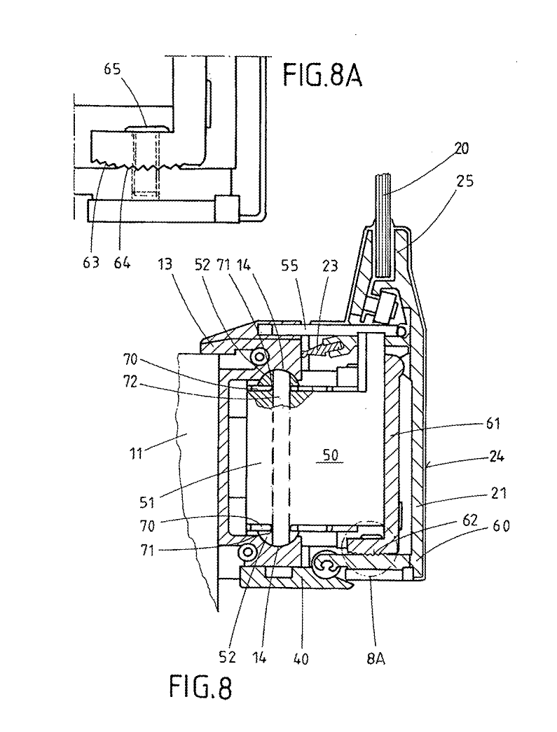

FIG. 8 shows a side view of the arrangement of the two edge sections, with the panel in the closed position;

FIG. 8A shows an enlarged view of the partial area 8A circled in FIG. 8; and

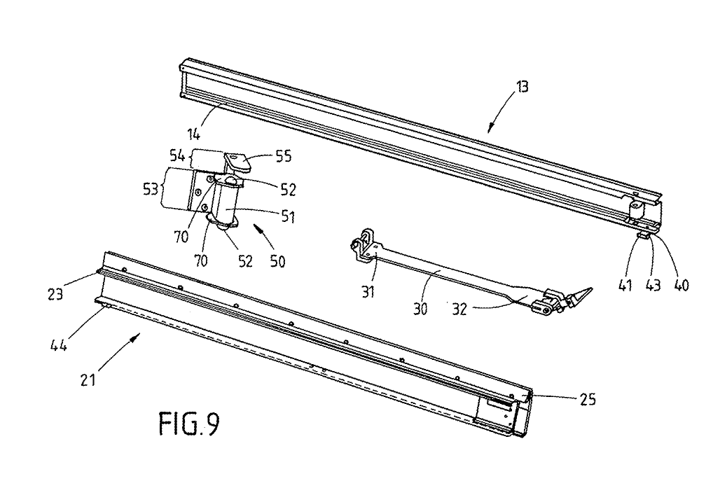

FIG. 9 shows an exploded view of the two edge sections, the control part, and the hinge.

FIG. 1 shows a sales counter 10 with a counter framework structure 11 and a panel 20. The panel 20 is in its closed position 20.2. In this exemplary embodiment, the panel is straight. The panel 20 is arranged on the front side 12 of the sales counter 10. In the closed position 20.2 shown here, only the first edge section 21 can be seen. The outside surface 24 of the first edge section 21 has no further embellishment. It is possible, however, to provide a coating or a facing, etc., or the panel 20 can be arranged directly on the outside surface 24 of the first edge section 21, depending on the overall visual appearance desired.

FIG. 2 shows a top view of the sales counter 10 of FIG. 1. Here, too, the panel 20 is in its closed position 20.2. In the top view, however, it is possible to see not only the first edge section 21 but also the second edge section 13. In addition, the cover 55 can be seen, which extends over the top of the opening device in the area of the hinge 50. This will be explained later in greater detail.

FIGS. 3 and 4 show the sales counter 10 of FIGS. 1 and 2 but with the panel 20 in the open position 20.1. It can be seen that the panel 20 has been swung out to bring it into the open position 20.1. So that this can be done, one of the ends 22 of the first edge section 21 is free to slide in the edge section 13. In addition, a control part 30 is provided, which, in this exemplary embodiment, is arranged so that it can pivot on both sections 13, 21 but is unable to slide. For this purpose, the one end 31 of the control part 30 is hinged to the first edge section 21, whereas its other end 32 is hinged to the second section 13. The control part 30 serves to control the movement of the first edge section 21, i.e., of the hinge 50. In this exemplary embodiment, the control part 30 functions simultaneously as a support arm and carries the weight of the panel 20. It is obvious that another type of design is also possible in which, for example, several support arms are provided or in which the weight of the panel 20 is supported in some other way. At the end area 27 of the first edge section 21 and at the end areas 15 of the second section 13, there are caps 16, which cover the sections 13, 21 toward the outside. Thus a uniform overall visual appearance is obtained, and foreign bodies are prevented from intruding into the sections 13, 21.

Additional embodiments of the sales counter 10 are shown in FIGS. 5 and 6. The individual sales counters 10 are assembled into so-called counter landscapes. All of the elements of the counter landscape can be equipped with an inventive opening device. The inventive device is able to bring the panels 20 into their open position 20.1 on so-called outside corners, as shown in FIG. 5, as well as on inside corners, as shown in FIG. 6. The panels 20 in FIGS. 5 and 6 are curved spherically. This shows that the opening device can be used in conjunction with panels 20 of a wide variety of different designs, especially in the case of inside and outside corners, which are difficult to equip with the known opening mechanisms. The panels 20 can be straight, curved, or spherical or have any other desired type of design.

FIG. 7 shows the detailed construction of the inventive opening device. A first edge section 21 and a second such section 13 can be seen. Between these sections, the control part 30 is arranged, one end 31 of which is hinged to the first section 21, while the other end 32 is hinged to the second section 13. The first edge section 21 carries the panel 20, which is in its open position 20.1 here. The second section 13 is fastened to the framework structure 11 of the counter. In the upper area 26 of the first edge section 21, it is possible to see the sealing lip 23, which ensures that the sections 13, 21 are sealed off against the counter framework structure 11. In addition, one can see the hinge 50, which comprises a cylinder 51, in which a spring element or an elastic element is arranged, which tries to press the two balls 52 outward. In the upper area 54 of the hinge 50, the cover 55 can be seen, which ensures that the device is also protected from above in the area of the hinge 50 for the purpose of preventing dirt from falling in and to create a more attractive overall visual impression.

It can also be seen that the first edge section 21 comprises a cap 16 on its end 27, and that the second section 13 also has such a cap on its end 15, the caps having the effect of making it impossible to see into the sections 13, 21 from the outside when the panel 20 is in the closed position 20.2.

The catch 40 can be seen especially clearly in FIG. 7A, wherein a guide surface 41, a projection 42, and a receptacle 43 are provided on the second section 13; these components can cooperate with a protrusion 44 on the first section 21. When the panel 20 is now moved from its open position 20.1 into its closed position 21.2, the protrusion 44 on the first section 21 is guided over the guide surface 41 in such a way that it overcomes the projection 42 and can enter the receptacle 43. To return the panel 20 into the open position 20.1 again, it must be raised slightly by the worker, so that the protrusion 44 leaves the receptacle 43 and can overcome the projection 42. The position of the catch 40 can also be shifted in order to align the panel 20, which is important in terms of achieving a uniform overall visual impression especially when the device is used in a counter landscape.

FIG. 8 shows a side view of the opening device but without the caps 16, wherein the panel 20 is in its closed position 20.2. The panel 20 is secured in the first edge section 21 by a clamping section 25. It should be obvious that there are other possible ways in which the panel 20 can be fastened to the first edge section 21. It is possible to see the sealing lip 23, which extends from the first section 21 to the second section 13, thus sealing off the intermediate space between the two sections 13, 21 against dirt and liquids.

The hinge 50 comprises the cylinder 51, wherein two balls 52 project from the open interior 53 of the cylinder 50; these balls are pushed outward by a spring element (not shown) present inside the cylinder 51. Instead of a spring element, it would obviously also be possible to provide some other type of elastic element, a solid spacer, or the like. It is also possible, however, to support the two balls 52 directly against each other, without the intermediate presence of some other element. A spring element, an elastic element, or even a solid spacer serves merely to compensate for manufacturing tolerances and thus to limit the play of the balls 52 and of the hinge 50. The two balls 52 engage in two grooves 14 in the second edge section 13. When the panel 20 is now moved into its open position 20.1, the hinge 50 slides along the section under the guidance of the balls 52 engaging in the semicircular grooves 14 in the section 13. The design with the two balls 52 and the semicircular grooves 14 makes it possible for the hinge 50 to slide easily and with low friction.

In this exemplary embodiment, it can be seen that the hinge 50 is locked in place when the panel 20 is in the closed position 20.2. As a result, the hinge 50 is not under any load when the panel is in the closed position 20.2. Two latching plates 70 are provided, each of which comprises an opening 71. A cam 72, designed here as a pin, can be introduced into the openings. When the panel 20 is brought into its closed position 20.2, the cam 72 moves automatically into the openings 71 in the latching plates 70 and relieves the balls 52 of their load.

It also possible to see that the first edge section 21 comprises two parts, namely, a part which carries the panel 20, called the “panel part” 60 in the following, and a pivoting part 61 attached to the control part 30, to which the panel part 60 is fastened. The pivoting part 61 comprises a curved surface 62, on which several stops 63 in the form of teeth in the present case are arranged, as can be seen in the enlarged diagram of FIG. 8A. The panel part 60 comprises several counterstops 64 in the form of opposing teeth. Of course, it would also be possible to provide fewer stops 63 and fewer counterstops 64. The inclination of the panel 20 changes depending on which of the stops 63 is brought into effective engagement with which of the counterstops 64. The finer the gradations of the sets of teeth, the greater the precision with which the inclination of the panel 20 can be adjusted. Once the desired tilt of the panel 20 is reached, the stops 63 and counterstops 64 can be fastened detachably to each other, especially, as in the exemplary embodiment shown here, by means of a screw joint 65. In this case it is possible in particular to align the panel 20 more precisely, which is important especially when the device is to be installed in a counter landscape.

FIG. 9, finally, shows once again the individual components of the inventive opening device. It is possible to see the first edge section 21 with the sealing lip 23. The protrusion 44, which can interact with the catch 40 to hold the panel 20 in its closed position 20.2 is also visible.

The control part 30 is also shown, one end 31 of which can be fastened to the first section 21, while the other end 32 is fastened to the second section 13. The second section 13 is also shown, wherein the semicircular grooves 14 can also be seen. The catch 40 also appears, which, as before, comprises the guide surface 41, the projection 42, and the receptacle 43 for cooperation with the protrusion 44 on the first edge section 21.

Finally, the hinge 50 is shown. It can be seen here that the two balls 52 project from the open interior 53 of the cylinder 51 and are thus able to engage in the semicircular grooves 14 in the second edge section 13. They are pushed outward by the spring element (not shown) located inside the cylinder 51. It can also be seen that the hinge 50 comprises a cover 55 in its upper area 54 to seal off the joint 50 against the counter framework structure 11 when the panel 20 is in the closed position 20.2. This results in a better overall visual impression, and dirt and foreign bodies in the area of the hinge 50 are prevented from intruding into the opening device.

In conclusion, it should be pointed out that the exemplary embodiments presented here are merely possible realizations of the invention. The invention is not limited to them. Instead, variations and modifications are also possible. Instead of glass, for example, the panel could consist of some other material such as plastic.

### LIST OF REFERENCE NUMBERS

10 sales counter
11 framework structure of the counter
12 front side of 10
13 second edge section
14 groove
15 end area of 13
16 cap
20 panel
20.1 open position of 20
20.2 closed position of 20
21 first edge section
22 end of 21
23 sealing lip
24 outside surface of 21
25 clamping section
26 upper area of 21
27 end area of 21
30 control part
31 one end of 30
32 other end of 30
40 catch
41 guide surface
42 projection
43 receptacle
44 protrusion
50 hinge
51 cylinder
52 ball
53 open interior of 51
54 upper area of 50
55 cover
60 panel part
61 pivoting part
62 curved surface
63 stop
64 counterstop
65 screw joint
70 latching plate
71 opening
72 cam

1-17. (canceled)

18. A device for opening a panel on a sales counter including a counter framework structure, wherein the panel is arranged in particular on a front side of the sales counter, the device comprising:
at least one first edge section, in or on which the panel can be held;
at least one second edge section that is fastenable to the counter framework structure;
and a single control part by which the first edge section with the panel can be swung away from the counter framework structure, wherein the panel has a closed position, in which the panel closes off the counter framework structure on the front side of the sales counter, and an open position, in which the panel is swung away from the counter framework structure, wherein the single control part has one end hinged directly to the first edge section, without interposition of any other levers or hinges, and another end directly hinged to the second edge section or to the counter framework structure without interposition of any other levers or hinges, wherein the control part is fastened to the first end section and to the second edge section with freedom to pivot but without freedom to slide, wherein the first edge section is hinged at one end directly, without interposition of any other levers or hinges, to the second edge section with freedom to slide and to rotate, and wherein the control part controls rotational and sliding movement of the first edge section.

19. The device according to claim 18, and further comprising a catch that latches the panel in the closed position on the counter framework structure and prevent the panel from being swung out unintentionally.

20. The device according to claim 19, wherein the catch comprises a guide surface on the counter framework structure or on the second edge section, the guide surface forming a projection, wherein a receptacle is formed behind the projection, and the catch also comprises a protrusion formed on the first edge section, which protrusion, when the panel is moved into the closed position is guidable over the guide surface and, after overcoming the projection, enters the receptacle.

21. The device according to claim 19, wherein, the catch is shiftable in a direction perpendicular to the counter framework structure and/or to the second edge section and fixable in place to align the panel.

22. The device according to claim 18, wherein at the one end, the first edge section comprises a hinge that is mounted on the second edge section freely slideable, wherein the hinge is movable along at least one groove in the second edge section.

23. The device according to claim 22, wherein the hinge comprises a cylinder, in an interior of which a spring element or an elastic element and two balls are installed, the balls project partially from the interior of the cylinder at a top and a bottom of the cylinder, the spring element pressing the balls outwardly, wherein the second edge section comprises two semicircular grooves, in each of which one of the balls projecting from the cylinder engages, as a result of which the hinge can slide along the second edge section under guidance of the two balls.

24. The device according to claim 22, further comprising a cover provided in an upper area of the hinge and above the second edge section, so as to extend over the hinge when the panel is in the closed position.

25. The device according to claim 18, wherein a position of the control part is adjustable in a height direction relative to the first edge section and/or to the second edge section.

26. The device according to claim 18, wherein inclination of the panel is adjustable.

27. The device according to claim 26, wherein the inclination of the panel is adjustable in increments of ±0.5°.

28. The device according to claim 26, wherein the inclination of the panel is adjustable by a total of ±3°.

29. The device according to claim 26, wherein the first edge section comprises two parts, namely, a part that carries the panel and a pivoting part fastened to the control part and to which the panel part is fastenable; and wherein the pivoting part comprises a curved surface that has at least one stop, whereas the panel part comprises at least one counterstop, wherein the inclination of the panel changes depending on which of the stops is brought into effective engagement with which of the counterstops, and wherein the panel part is fastened detachably to the pivoting part by fixation of the stops and counterstops to each other.

30. The device according to claim 29, further comprising a screw joint to fix the stops and counterstops together.

31. The device according to claim 18, wherein the first edge section comprises at least one sealing lip in an upper area.

32. The device according to claim 18, wherein an outer side of the first edge section comprises a facing in the form of a shield or coating separately attached to the first edge section or by attachment of the panel to the outer side of the first edge section.

33. The device according to claim 18, wherein when in its open position, the panel can be swung out until at least 75% of the sales counter is accessible from the front side.

34. The device according to claim 26, wherein the panel has a straight, spherical, or curved design, wherein the panel is held in place by a clamping section, which is directly or indirectly a component of the first edge section.

35. The device according to claim 18, further comprising a cap at at least one end of the first edge section and/or of the second edge section, so as to seal off an open end of the edge section from the outside.

36. The device according to claim 22, further comprising a latching mechanism that holds the hinge in the closed position of the panel, and at least one latching plate that comprises at least one opening, into which a cam is introduceable to hold the hinge in place.
